(19) United States
(12) Patent Application Publication
(10) Pub. No.: US 2008/0075456 A1
(43) Pub. Date: Mar. 27, 2008

(54) DIGITAL CAMERA MODULE AND ASSEMBLING METHOD WITH SAME

(75) Inventors: STEVEN WEBSTER, Tu-Cheng (TW); YU-CHIEH CHENG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/687,142

(22) Filed: Mar. 16, 2007

(30) Foreign Application Priority Data
Sep. 22, 2006 (CN) 200610062741.8

(51) Int. Cl. H04N 1/46

(52) U.S. Cl. 396/535

(57) ABSTRACT

A portable electronic device (400) includes a housing (402) and a digital camera module (200). The housing has at least one arcuate housing surface section (4024) at one end thereof. The digital camera module is received in the housing proximate the one end thereof. The digital camera module includes at least one contact portion. Each contact portion has an arcuate contact surface (6400), and each such contact portion tightly engages a corresponding arcuate housing surface section. Owing to the tight engagement of such arcuate surfaces, the top surface of the digital camera module may fit closely against the housing so as to more fully use the space in the portable electronic device. This would help satisfy the miniaturization requirement of the portable electronic device.

### BACKGROUND OF THE INVENTION

1. Field of the Invention

The present invention relates to digital camera modules and, particularly, to a digital camera module used in a mobile/cellular phone and also to a method of assembly thereof.

2. Description of Related Art

In recent years, digital cameras have been incorporated in portable electronic device such as personal computers, web cams, mobile computers, mobile telephones, personal digital assistants (PDAs), and the like. In such digital cameras, a good image quality is not only desired but so is integration of the digital camera and the portable electronic device without unnecessarily increasing the size of the portable electronic device.

Referring to FIG. 3, a conventional digital camera module 300 is assembled in a mobile phone 100. The digital camera module 300 includes a seat 301 and a barrel 302. The barrel 302 is threaded to the seat 301. The barrel 302 and the seat 301 both have a right angle edge on a top surface thereof. The mobile phone 100 includes a main body 1001. The main body 1001 has a curved portion 1004 and a flat portion 1005. A critical position 1002 is formed between the curved portion 1004 and the flat portion 1005. In assembly, if the right angle edge of the barrel 302 conforms to the critical position 1002 or offsets toward the flat portion 1005, an unnecessarily large space 1003 in the main body 1001 will exist. Accordingly, a space effectively occupied by the digital camera module 300 in the mobile phone 100 is increased, either requiring an increase in the size of the mobile phone 100 or otherwise reducing the available space for other components within the mobile phone 100. If the right angle edges of the seat 301 and the barrel 302 should directly contact the curved portion 1004, the main body 1001 could easily be damaged because the right angle edge of the seat 301 and the barrel 302 is usually very sharp. In addition, owing to the right angle edge of the barrel 302 contacting/resisting the curved portion 1004, a vertical clearance will exist between the barrel 302 and the flat portion 1005. Thus, an unnecessary space between the digital camera module 300 and the mobile phone 100 also exists. Accordingly, the digital camera 300 cannot effectively use the internal space in the mobile phone 100 and thus cannot satisfy the requirement of miniaturization.

Therefore, a digital camera module, which will fully utilize the existing internal space in the mobile phone, is desired in order to overcome the above-described shortcomings.

### SUMMARY OF THE INVENTION

One embodiment of a portable electronic device includes a housing and a digital camera module. The housing has at least one arcuate housing surface section at one end thereof. The digital camera module is received in the housing proximate the one end thereof. The digital camera module includes at least one contact portion. Each contact portion has an arcuate contact surface, each contact portion thereby tightly engaging a corresponding arcuate housing surface section.

Other advantages and novel features will become more apparent from the following detailed description when taken in conjunction with the accompanying drawings.

### BRIEF DESCRIPTION OF THE DRAWINGS

Many aspects of the digital camera module can be better understood with reference to the following drawings. The components in the drawings are not necessarily drawn to scale, the emphasis instead being placed upon clearly illustrating the principles of the present digital camera module and its potential applications. Moreover, in the drawings, like reference numerals designate corresponding parts throughout the several views.

FIG. 1 is a cut-away view of a digital camera module, according to one embodiment;

FIG. 2 is a partially cross-sectional view showing the digital camera module of FIG. 1 used in a mobile phone; and

FIG. 3 is a partially cross-sectional view showing a typical digital camera module used in a mobile phone.

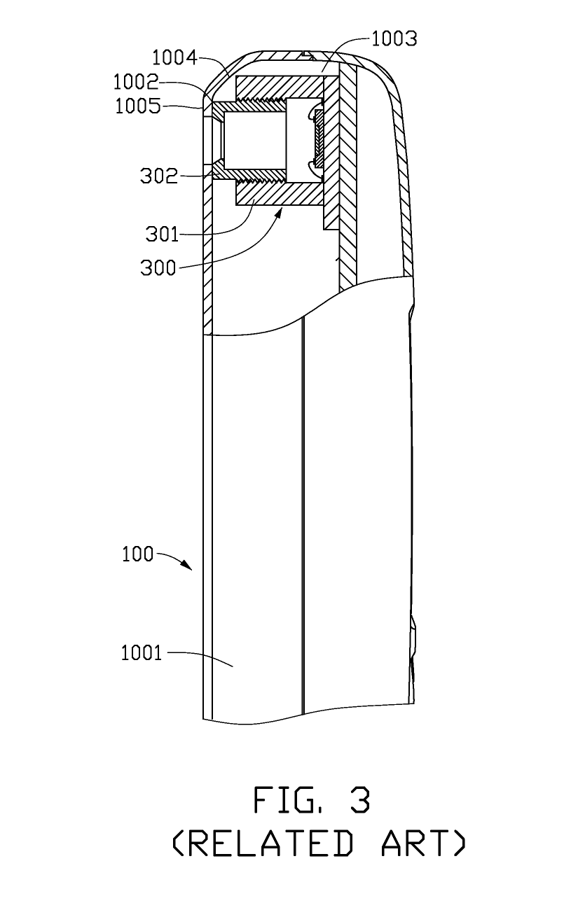

### DETAILED DESCRIPTION OF THE EMBODIMENTS

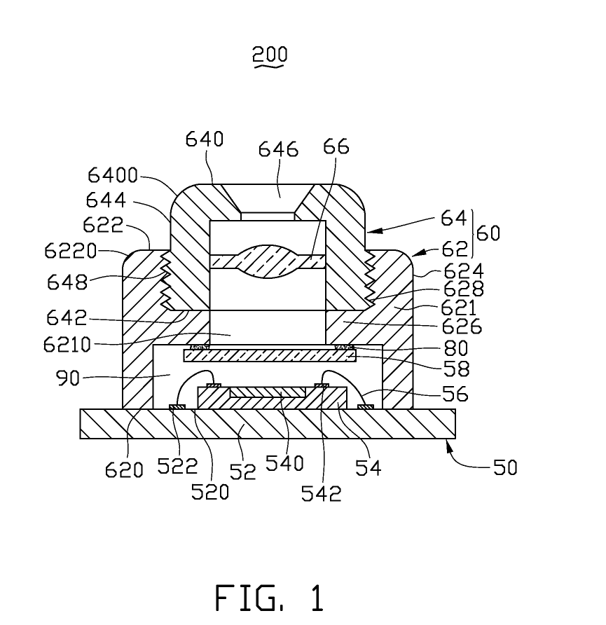

Referring now to the drawings in detail, FIG. 1 shows a digital camera module 200, in accordance with one embodiment. The digital camera module 200 includes an image sensor module 50 and a holder 60.

The image sensor module 50 includes a base 52, an image sensor chip 54, a number of bonding wires 56, and a cover 58. The holder 60 includes a seat 62, a barrel 64, and a lens element 66.

The base 52 is substantially board-shaped and is usually made of ceramic or glass material. The base 52 has a top surface 520, and a plurality of base pads 522 arranged on the top surface 520.

The image sensor chip 54 is positioned on the top surface 520 of the base 52. A top surface of the image sensor chip 54 is arranged with a photosensitive area 540 and a number of chip pads 542 arrayed around the photosensitive area 540.

The bonding wires 56 can be made of a conductive material, such as gold or aluminum alloy. One end of each bonding wire 56 is connected/joined to a respective chip pad 542 of the image sensor chip 54, and the other end of each bonding wire 56 is connected/joined to a respective base pad 522, so as to transmit electric signals out of the image sensor chip 54 to the base pad 522 of the base 52.

The cover 58 is transparent and is laid over the image sensor chip 54, which receives light transmitted through the cover 58.

The seat 62 is a hollow cylinder in shape and includes a seat body 621. The seat body 621 has a hole 6210, defined by an inner peripheral wall thereof. An annular flange 626 extends from the inner peripheral wall of the seat body 621. A size of an inner diameter of the flange 626 is larger than that of the photosensitive area 540 of the image sensor chip 54. The flange 626 divides the hole 6210 into a first space and a second space. The first space has a first open end 620, and the second space has a second open end 622. The first open end 620 encloses the top surface 520 of the base 52. The second open end 622 has an arcuate/beveled edge 6220 (i.e., a chamfer) at an intersection between a top surface and an outer peripheral surface 624 of the seat. Such an arcuate edge 6220 thereby defines an arcuate contact surface section. The arcuate edge 6220 is rounded through/over an angular range (e.g., 45°˜90°) and is configured (i.e., structured and arranged) for tightly/matingly engaging with a housing of a portable electronic device, especially an arcuate/curved housing surface section (e.g., a housing corner). The first space with the first open end 620 is configured for receiving the image sensor chip 54, and the second space with the second open end 622 is configured for receiving the barrel 64. An inner peripheral wall of the second space defines an inner thread 628. The cover 58 is adhered to the flange 626 by glue/adhesive 80 and, therefore, seals the image sensor chip 54 in the second space, so as to form a sealing space 90.

The barrel 64 is substantially a hollow cylinder with a top end 640 and a bottom end 642, so that light can be transmitted therethrough. The top end 640 defines a through hole 646 configured for facilitating entry of light into the barrel 64. The lens element 66 is secured in the barrel 64 (advantageously, attached directly to the interior thereof) and is configured for receiving incoming light that enters from the outside. The lens element 66 is aligned with an axis of the through hole 646 and a central axis of the image sensor chip 54. The barrel 64 has an outer thread 648 defined in an outer peripheral wall thereof. The outer thread 648 is configured for threadedly engaging with the inner thread 628 of the seat 62. The top end 640 of the barrel 64 also has an arcuate edge 6400 (i.e., a chamfer), which thereby defines an arcuate contact surface section, at an intersection between a top surface and an outer peripheral surface 644 of the barrel 64. The arcuate edge 6400 is configured for tightly/matingly engaging with a housing of a portable electronic device, especially a curved housing portion.

A method of assembling the digital camera module 200 is disclosed by way of example. Firstly, the base 52 is provided, and the top surface 520 of the base 52 is coated with glue/adhesive. The image sensor chip 54 is placed on the glue in order to directly connect the image sensor chip 54 to the base 52. Then, one end of each bonding wire 56 is connected to the base pads 522, and the other end of each bonding wire 56 is connected to the chip pad 542 by wire bonding technology. Accordingly, the image signal may be transmitted from the image sensor chip 54 to the base 52.

After that, the seat 62 is made by injection molding technology and thereby form the arcuate edge 6220 and the inner thread 628 in the process. The cover 58 is, usefully, directly bonded to the flange 626 by glue/adhesive 80. The barrel 64 is also made by injection molding technology, thereby yielding the arcuate edge 6400 and the outer thread 648. The lens element 66 is secured in the barrel 64. Then, the barrel 64 is connected to the seat 62 by means of a thread connection. After adjusting a focus until a clear image is attained, the barrel 64 is fixed on the seat 62 by an adhesive/glue. Finally, the seat 62 together with the barrel 64 is placed on the top surface 520 of the base 52. Glue/adhesive is coated on the base 52 around the barrel 62 so as to seal the image sensor chip 54 directly to the base 52 and to thus be fixed within the second space. Thus, the assembly process of the digital camera module 200 is completed. It can be seen that the photosensitive area 540 of the image sensor chip 54 is protected from outside pollution due to the sealing space 90.

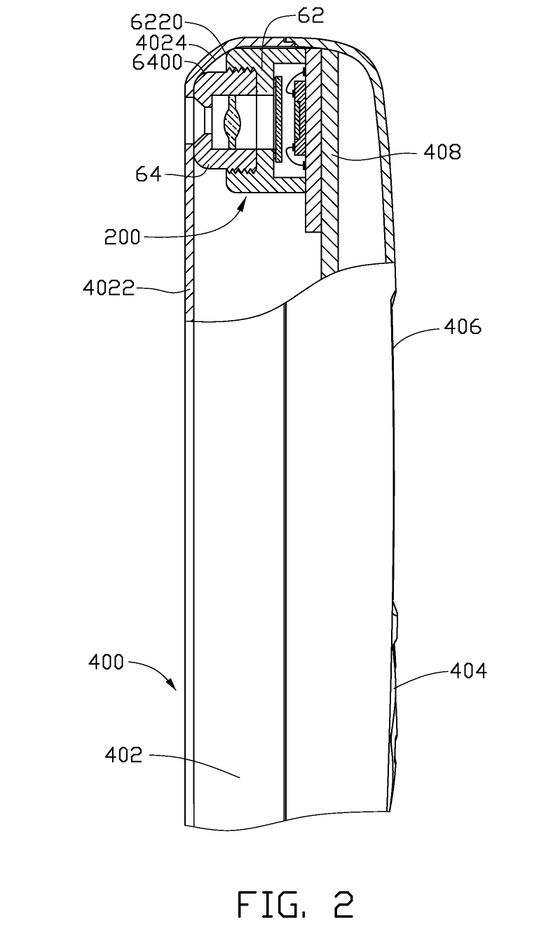

The digital camera module 200 can advantageously be used in portable electronic devices, such as mobile phones. Referring to FIG. 2, the mobile phone 400 includes a housing 402, a keypad 404, and a display 406. A printed circuit board 408 is received in the housing 402. The digital camera module 200 is positioned on the printed circuit board 408. The housing 402 includes a flat portion 4022 and an arcuate portion 4024. When the digital camera module 200 is assembled in the mobile phone 400, the digital camera module 200 is firstly positioned on the printed circuit board 408. Then, the housing 402 encloses the printed circuit board 408, with the arcuate edge 6400 of the barrel and the arcuate edge 6220 of the seat 62 contacting the arcuate portion 4024 of the housing 402 of the mobile phone 400. Thus, the assembly process of the digital camera module 200 in the housing 402 is completed. Owing to the arcuate edge 6400 of the barrel and the arcuate edge 6220 of the seat 62 corresponding to the arcuate portion 4024 of the housing 402 of the mobile phone 400, the top portion of the barrel 64 and the seat 62 may tightly contact (i.e., fit closely against) the housing 402 so as to fully utilize the space in the mobile phone 400 (i.e., more compact space usage of digital camera module 200 within the mobile phone 400). This would help satisfy the miniaturization requirement of the mobile phone.

In still further alternative embodiments, the seat 62 and the barrel 64 may be molded together as a whole during manufacture (molding offers the advantage of simplified manufacture but eliminates the opportunity of an adjustable focus). Alternatively, the barrel 64 may be fixed relative to the seat 62 by means of glue or other adhesive or by a plastic welding procedure.

In a still further alternative embodiment, the adhesive/glue can be replaced by any other appropriate fastening means, for example, a threaded fastener.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable electronic device comprising:
a housing having at least one arcuate housing surface section at one end thereof; and
a digital camera module received in the housing proximate the one end thereof, the digital camera module including at least one contact portion, each contact portion having an arcuate contact surface, each contact portion thereby tightly engaging a corresponding arcuate housing surface section.

2. The portable electronic device as claimed in claim 1, wherein the digital camera module comprises a holder and an image sensor module.

3. The portable electronic device as claimed in claim 2, wherein the holder includes a barrel and a seat.

4. The portable electronic device as claimed in claim 3, wherein the barrel includes a top surface and a peripheral surface, and one given contact portion is disposed at an intersection between the top surface and the peripheral surface of the barrel.

5. The portable electronic device as claimed in claim 3, wherein the seat includes a top surface and a peripheral surface, and one given contact portion is disposed at an intersection between the top surface and the peripheral surface of the seat.

6. The portable electronic device as claimed in claim 1, wherein the arcuate contact surface is rounded through an angular range of about 45°˜90°.

7. The portable electronic device as claimed in claim 1, wherein the portable electronic device is a mobile phone.

8. A digital camera module for being assembled in a housing having at least one arcuate housing surface section at one end thereof, the digital camera module comprising:
an image sensor chip module; and
a holder mounted on the image sensor chip module and in optical alignment therewith, the holder including at least one arcuate edge; each arcuate edge being configured for engaging a corresponding arcuate housing surface section of the housing.

9. The digital camera module as claimed in claim 8, wherein the holder includes a barrel and a seat, the barrel includes a top surface and a peripheral surface, and one given arcuate edge is disposed on an intersection between the top surface and the peripheral surface of the barrel.

10. The digital camera module as claimed in claim 8, wherein the holder includes a barrel and a seat, the seat includes a top surface and a peripheral surface, and one given arcuate edge is disposed on an intersection between the top surface and the peripheral surface of the seat.

11. The digital camera module as claimed in claim 8, wherein the arcuate contact surface is rounded through an angular range of about 45°˜90°.

12. A method of assembling a digital camera module in a portable electronic device, comprising the steps of:
providing a base;
mounting an image sensor chip on the base;
forming a holder with at least one arcuate holder surface adjacent a respective top holder surface thereof, the forming step being performed using an injection molding technique;
positioning the holder on the base so as to enclose the image sensor chip in order to form a digital camera module;
providing a housing having at least one arcuate housing surface section at one end thereof; and
receiving the digital camera module in the housing, each arcuate holder surface engaging a corresponding arcuate housing surface section.

13. The method of assembling a digital camera module in a portable electronic device as claimed in claim 12, wherein the holder includes a barrel and a seat, the barrel includes a top surface and a peripheral surface, and one given arcuate holder surface is disposed at an intersection between the top surface and the peripheral surface of the barrel.

14. The method of assembling a digital camera module in a portable electronic device as claimed in claim 12, wherein the holder includes a barrel and a seat, the seat includes a top surface and a peripheral surface, and one given arcuate holder surface is disposed at an intersection between the top surface and the peripheral surface of the seat.
